(19) United States
(12) Patent Application Publication
(10) Pub. No.: US 2019/0257978 A1
(43) Pub. Date: Aug. 22, 2019

(54) OBJECT MONITORING DEVICE USING SENSOR

(71) Applicant: FANUC CORPORATION, Yamanashi (JP)

(72) Inventors: Minoru NAKAMURA, Yamanashi (JP); Atsushi WATANABE, Yamanashi (JP); Yuuki TAKAHASHI, Yamanashi (JP); Takahiro IWATAKE, Yamanashi (JP)

(21) Appl. No.: 16/245,260

(22) Filed: Jan. 11, 2019

(30) Foreign Application Priority Data
Feb. 19, 2018 (JP) 2018-026919

(51) Int. Cl. G01V 99/00; G06T 7/70; G01S 17/02; G01S 13/04

(52) U.S. Cl. CPC G01V 99/00; G06T 7/70; G01S 17/026; G06T 2207/10012; G06T 2207/10028; G06T 2207/30232; G06T 2207/10044; G01S 13/04

(57) ABSTRACT

A monitoring device capable of properly detecting an object, even when a blind zone may occur for a sensor. The monitoring device has a sensor configured to a predetermined spatial area, and a judging section configured to judge presence or absence of an object within a predetermined monitoring area in the spatial area, based on measurement data obtained by the sensor. The judging section is configured to be previously set as to whether or not, when the sensor detects that the object exists within an intermediate area between the sensor and the monitoring area, the judging section judges that the object exists within the monitoring area, on the grounds of the existence of the object within the intermediate area.

### BACKGROUND OF THE INVENTION

### 1. Field of the Invention

The preset invention relates to an object monitoring device using a sensor.

### 2. Description of the Related Art

In a conventional technique, by using a range image measurement device such as a stereo vision device or a range finder, interference between the range image and a designated area is checked, and then, approach of an object into the designated area and a distance to the object are detected (e.g., see JP 2003-162776 A).

Further, in order to avoid interference or collision between a robot and an operator, a technique to use a three-dimensional sensor or a camera so as to measure a working area of the robot is well-known (e.g., see JP 2010-208002 A, JP 2012-223831 A and JP 2017-013172 A).

In a monitoring device configured to detect existence of an object within a predetermined monitoring area by using a sensor, a blind zone on monitoring may be generated due to the existence of an object outside the monitoring area. In such a case, in view of safety, the monitoring device usually judges that an object exists in the monitoring area. However, in case that it is judged that the object exists even if the object does not actually exist in the monitoring area, an apparatus within the monitoring area may be unnecessarily stopped, and/or an operator within the monitoring area may be forced to act so that a blind zone is not generated due to the motion of the operator.

### SUMMARY OF THE INVENTION

One aspect of the present disclosure is a monitoring device comprising: at least one sensor configured to a predetermined spatial area; and a judging section configured to judge presence or absence of an object within a predetermined monitoring area in the spatial area, based on measurement data obtained by the sensor, wherein the judging section is configured to be previously set as to whether or not, when the sensor detects that the object exists within an intermediate area between the sensor and the monitoring area, the judging section judges that the object exists within the monitoring area, on the grounds of the existence of the object within the intermediate area.

### BRIEF DESCRIPTION OF THE DRAWINGS

The above and other objects, features and advantages of the present invention will be made more apparent by the following description of the preferred embodiments thereof, with reference to the accompanying drawings, wherein:

FIG. 1 is a view exemplifying a schematic configuration of a monitoring device;

FIG. 2 is a view showing a function of the monitoring device;

FIG. 3 is a view explaining a positional relationship between a monitoring area and an intermediate area;

FIG. 4 shows an example in which one sensor monitors a plurality of monitoring areas;

FIG. 5 shows an example in which two sensors monitor one monitoring area;

FIG. 6 shows an example in which a plurality of sensors monitor a plurality of monitoring areas; and

FIG. 7 shows another example in which a plurality of sensors monitor a plurality of monitoring areas.

### DETAILED DESCRIPTIONS

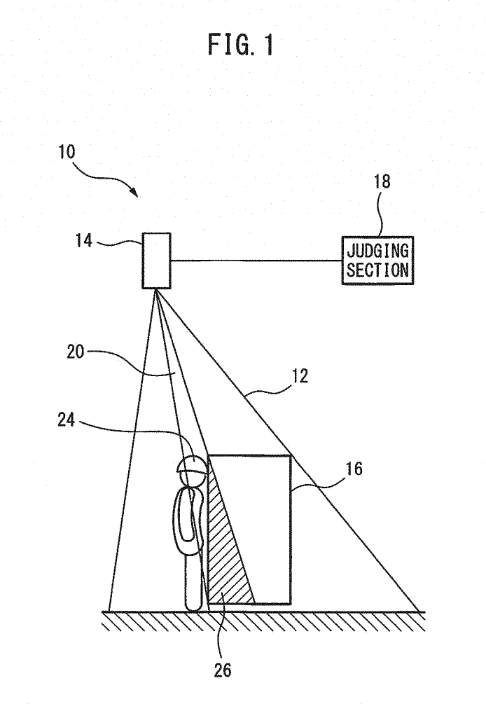

FIG. 1 schematically shows an object monitoring device (hereinafter, also referred to as a monitoring device) 10 according to a preferred embodiment, and a monitoring area 16 to be monitored by monitoring device 10. Monitoring device 10 includes: a first sensor 14 configured to a predetermined spatial area 12; and a judging section 18 configured to judge presence or absence of an object within a monitoring area 16 predetermined in spatial area 12, based on measurement data obtained by first sensor 14.

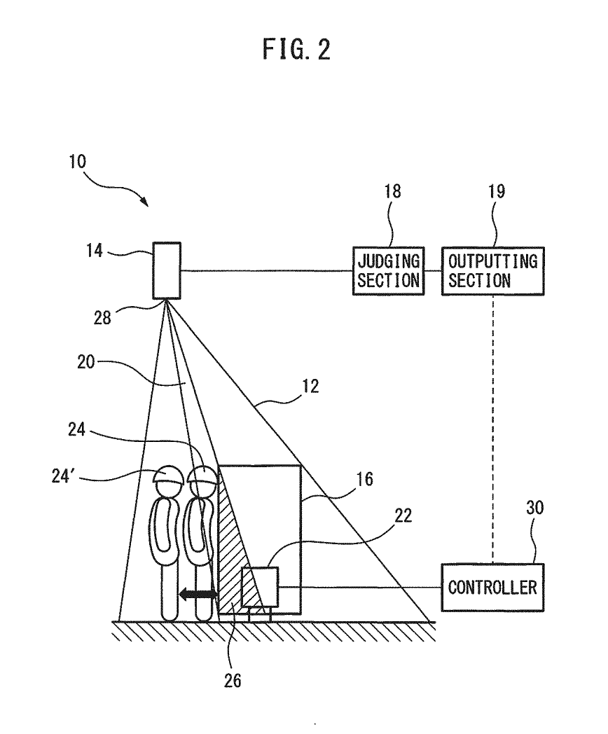

In the present embodiment, spatial area 12 is set within a measurement range of first sensor 14, and monitoring area 16 is set in spatial area 12, so that entrance or existence of the object in monitoring area 16 can be (preferably, always) monitored. For example, such settings can be carried out by a designer of a monitoring system via a suitable input device, etc., and contents of the settings can be stored in a memory (not shown), etc., of monitoring device 10. In this case, as shown in FIG. 2, monitoring area 16 is set as a (generally cuboid) area defined based on a size and/or a movable range of a dangerous object (e.g., a robot) 22, and monitoring area 16 may be virtually determined by (a processor, etc., of) monitoring device 10. When object 24 such as a human enters monitoring area 16, an inputting section 19, configured to output a result of judgment of judging section 18, outputs information (e.g., a detection signal) representing that the object is detected in monitoring area 16. For example, the output information may be received by a controller 30 connected to robot 22 and configured to control the motion of robot 22. Controller 30 is configured to, after receiving the detection signal, cut off power to a motor for driving the robot, and/or output an alarm, etc.

As shown in FIG. 2, even when object 24 (e.g., an operator) does not exists in monitoring area 16, a blind zone may occur in monitoring area 16 due to object 24, depending on the positional relationship between sensor 14 and monitoring area 16. Concretely, when object 24 exists in an intermediate area 20, an area 26 within monitoring area 16 becomes a blind zone, and thus the presence or absence of the object within blind zone 26 cannot be judged based on the measurement data of sensor 14. In such a case, a conventional monitoring device is usually configured to output a result of judgment (e.g., a detection signal) representing that the object exists in the monitoring device, in view of safety. Therefore, in the prior art, as indicated by reference numeral 24 in FIG. 2, the operator is forced to carry out an operation without entering intermediate area 20 (i.e., while being well away from monitoring area 16), in order to avoid the above problem.

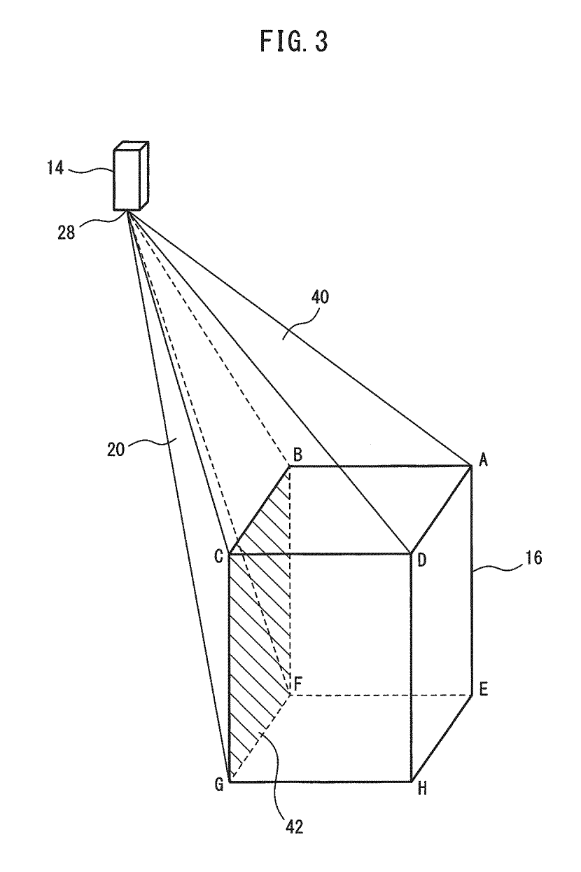

In the present disclosure, the “intermediate area” means a three-dimensional space, which is defined by surfaces defined by straight lines extending from a representative point 28 (e.g., a center of a camera lens) of sensor 14 to an outline (or contour) of monitoring area 16. When the objet exists in the intermediate area, at least a part of monitoring area 16 is included in a rear-projection area of the object with respect to representative point 28 of sensor 14, and the included part may be the blind zone. Concretely, as shown in FIG. 3, assuming that monitoring area 16 is a cuboid having eight vertexes A to H, intermediate area 20 corresponds to an area (having a four-sided pyramid shape) defined by representative point 28 of sensor 14 and four vertexes B, C, G and H. Therefore, when the object exists in intermediate area 20, the blind zone occurs in area 26. In other words, only blind zone 26, which may occur in monitoring area 16 due to operator 24, can be viewed from sensor 14 through intermediate area 20.

Judging section 18 of monitoring device 10 is configured to be previously set (e.g., by a designer of the monitoring system including monitoring device 10) as to whether or not, when first sensor 14 detects that the object exists within intermediate area 20, judging section 18 judges that the object exists within monitoring area 16, on the grounds of the existence of the object within intermediate area 20. In the embodiment, judging section 18 is previously set so that, when first sensor 14 detects that the object exists within intermediate area 20, judging section 18 does not judge that the object exists within monitoring area 16 (i.e., judging section 18 does not execute the object detection). In this case, (output section 19 of) monitoring device 10 does not output anything, and thus, the device (e.g., robot controller 30) for receiving the output from monitoring device 10 does not execute a process for stopping the motion of the dangerous object (e.g., for shutting power to a motor for driving the robot) within monitoring area 16. Therefore, even when the operator comes close to monitoring area 16, the robot can be prevented from unnecessarily being stopped, whereby an inconvenience of the system including the robot, such as a decrease in a working efficiency of the system, can be avoided.

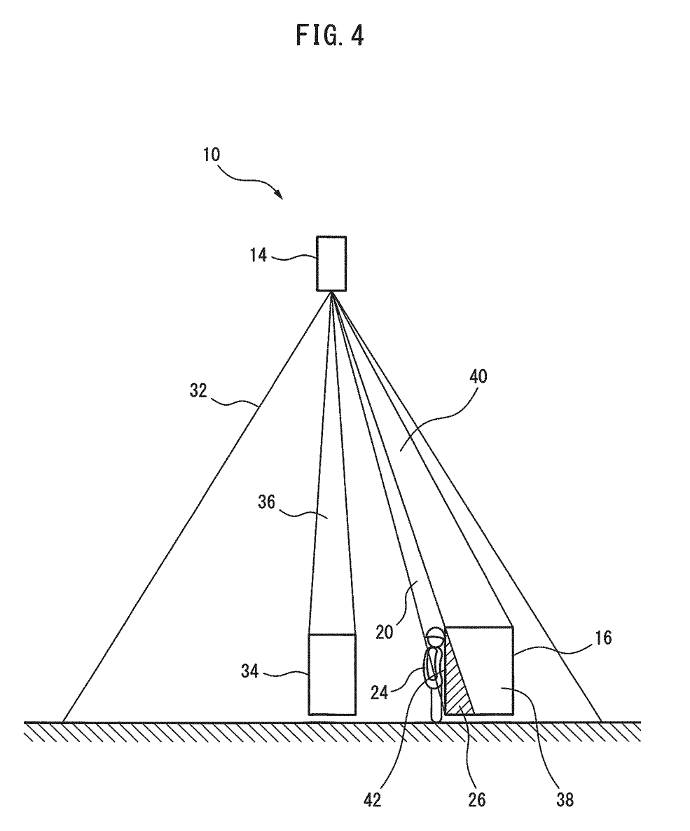

FIG. 4 shows an example in which a plurality of monitoring areas are defined in the spatial area. For example, when (sensor 14 of) monitoring device 10 can measure a spatial area 32 larger than spatial area 12 of FIG. 2, a second monitoring area 34 may be set or added, as well as first monitoring area 16 as described above. In the example of FIG. 4, a blind zone does not occur in second monitoring area 34 due to the existence of the object (concretely, it is not assumed that the object exists in a second intermediate area 36 between sensor 14 and second monitoring area 34). Therefore, monitoring device 10 may be set so that, when the object within intermediate area 36 is detected, outputting section 19 outputs a detection signal, etc., representing that the object is detected within second monitoring area 34. This is because, in such a case, in view of safety, it is preferable that it be judged that the object exists in monitoring area 34, when the existence or access of the object in or to intermediate area 36 is detected. As such, when the plurality of monitoring areas are defined, (judging section 18 of) monitoring device 10 may be previously set as to whether or not, when the object is detected within the intermediate area corresponding to each monitoring area, judging section 18 judges that the object exists within the monitoring area, on the grounds of the existence of the object within each intermediate area. Further, monitoring device 10 may output a result of judgment by the judging section as a detection signal, with respect to each monitoring area.

As exemplifying in FIG. 4, first monitoring area 16 may be divided into area 26, which may be the blind zone due to object 24, etc., as shown in FIG. 2, and area 38 which does not become the blind zone, whereby the intermediate may also be divided correspondingly. In the example of FIG. 4, the object (such as the operator) may enter intermediate area 20 relating to area 26/whereas it is not assumed that the object may enter intermediate area 40 relating to area 38. In the example of FIG. 3, intermediate area 40 is an area (having a four-sided pyramid shape) defined by representative point 28 of sensor 14 and four vertexes A, B, C and D. Therefore, monitoring area 16 may be (virtually) divided into a plurality of (in this case, two) monitoring areas, the intermediate area may also be divided correspondingly, and the above judgment process may be execute with respect to each of the divided intermediate areas. Concretely, when the existence of the object is detected in intermediate area 20, it is not judged that the object exists in monitoring area 16 on the grounds of the detection result, and thus monitoring device 10 does not output anything. On the other hand, when the existence or entrance of the object is detected in intermediate area 40, monitoring device 10 outputs the judgment (or the detection signal) representing that the object exists in monitoring area 16. By virtue of this, with respect to the area which cannot be the blind zone, the object detection with high-security can be carried out, in view of safety.

In this connection, the designation of intermediate area 20 (or the setting of the divided areas) may be carried out by specifying a field of view of sensor 14. For example, as shown in FIG. 3, by designating a surface 42 defined by vertexes B, C, G and F, the intermediate area may be designated. Otherwise, by designating (coordinates of) a three-dimensional area corresponding to area 26 by using a CAD, etc., the intermediate area may be designated. However, the method for setting the divided areas is not limited to such a surface-designation or area-designation.

As shown in FIG. 4, one monitoring area 16 may be divided into or set as two independent monitoring areas 26 and 38. Then, with respect to monitoring area 26, when the object is detected within intermediate area 20, monitoring device 10 may be set so as to not judge the presence or absence of the object in monitoring area 16 on the grounds of the detection result. However, areas 26 and 38 are inherently one monitoring area, and thus it is preferable that one monitoring result (or one signal) be output for the one monitoring area. Therefore, in such a case, (outputting section 19 of) monitoring device 10 may output the result of judgment of judging section 18, with respect to each group (in this case, with respect to area 16 including areas 26 and 38), obtained by integrating the monitoring areas. In this example, when the existence of the object is detected in one of areas 26 and 38, it is judged that the object exists in the integrated group (e.g., area 16), even if the existence of the object is not detected in the other of areas 26 and 38.

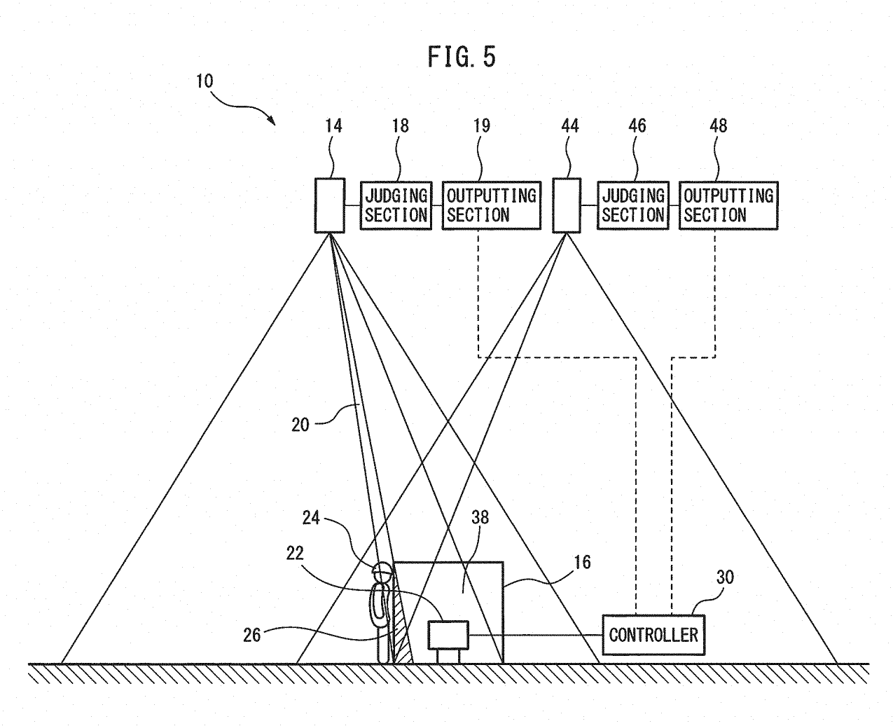

FIG. 5 shows an embodiment of a monitoring device including a plurality of sensors. As shown in FIG. 2, when only one sensor 14 is used, the object detection may not be correctly carried out with respect to the entirety of monitoring area 16, since monitoring area 16 includes a zone which may become the blind zone. Therefore, in the embodiment of FIG. 5, the plurality of sensors arranged at different positions are used, in order to solve the above problem. Concretely, this embodiment includes, in addition to the components of FIG. 2, a second sensor 44 arranged at a different position from first sensor 14, and a second judging section 46 configured to judge presence or absence of the object within a predetermined monitoring area (in this case, an area corresponding to blind zone 26 within monitoring area 16), based on measurement data obtained by second sensor 44. By virtue of this, with respect to area 26, which may become the blind zone relating to first sensor 14 due to the existence of the object (e.g., operator 24) in intermediate area 20, the object detection may be carried out based on the measurement data of second sensor 44. Further, with respect to area 38 in monitoring area 16 other than area 26, the object detection may be carried out based on the measurement data of first sensor 14. In addition, the result of process (judgment) of second judging section 46 may be output from an outputting section 48 connected to judging section 46 to controller 30, etc., as a form or a detection signal, etc.

As shown in FIG. 5, by using the plurality of sensors, the area, which may become the blind zone with respect to one sensor, can be detected by the other sensor, and thus the object detection can be correctly carried out with respect to the entirety of the monitoring area. When the object exists in intermediate area 20, an output for securing safety (representing that the object exists in the monitoring area) is not output from first sensor 14, and further, even when the existence of the object within area 26 cannot be detected, the output, representing that the object exists in the monitoring area, is not output. On the other hand, since second sensor 44 is positioned so that the blind zone relating to second sensor 44 does not occur in area 26 even if the object exists in intermediate area 20, the existence of the object in area 26 can be surely detected based on the measurement data of second sensor 44. In this regard, it is preferable that second judging section 46 judge that the object exists in monitoring area 16, when second sensor 44 detects that the object exists in an intermediate area between second sensor 44 and monitoring area 16.

In the embodiment of FIG. 5, it is not necessary that judging section 18 or 46 executes a process for integrating or collectively judging the outputs of the two sensors. Similarly, it is not necessary that controller 30 executes a process for integrating or collectively judging the output signals from the two judging sections (or the outputting sections). In other words, controller 30 may control robot 22 based on each output signal, e.g., may stop robot 22 when any of the output signals represents that the object exists in the monitoring area. Therefore, it is not necessary to connect between the sensors (or the judging sections) by a complicated wiring, etc., and further, the object detection can be correctly carried out without integrating or collectively judging the outputs of the two sensors (judging sections) with respect to the same monitoring area. Accordingly, a whole of the monitoring device can be constituted at a low cost.

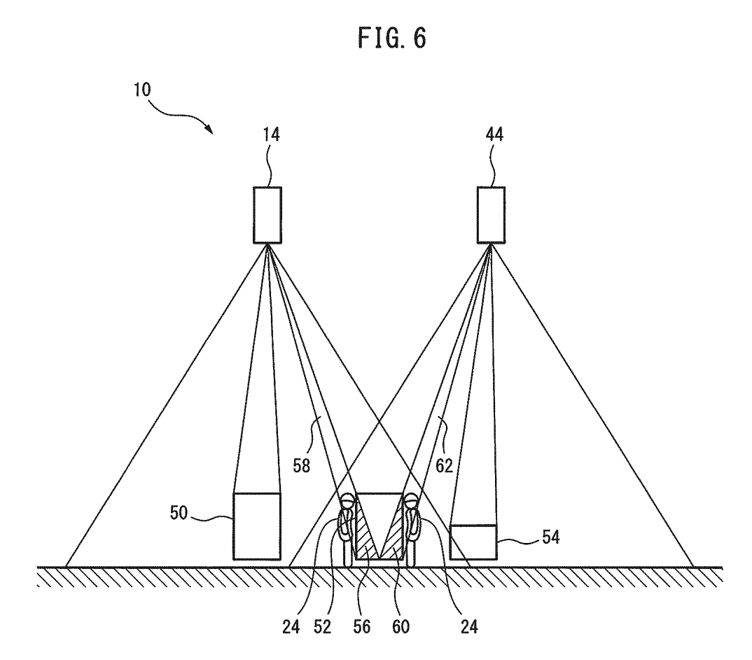

FIG. 6 shows another embodiment of a monitoring device including a plurality of sensors, in which two sensors are used to monitor three monitoring areas 50, 52 and 54 separated from each other. Normally, the arrangement of the monitoring areas and/or the sensors in the monitoring device may be designed or determined by a designer of a monitoring system including the monitoring device.

Since first sensor 14 is positioned generally just above left-side monitoring area 50, a blind zone does not occur in monitoring area 50. Similarly, since second sensor 44 is positioned generally just above right-side monitoring area 54, a blind zone does not occur in monitoring area 54.

On the other hand, in center monitoring area 52, an area 56 within monitoring area 52 may become a blind zone due to the existence of the object within an intermediate area 58 between first sensor 14 and monitoring area 52, and similarly, an area 60 within monitoring area 52 may become a blind zone due to the existence of the object within an intermediate area 62 between second sensor 44 and monitoring area 52. In this case, second sensor 44 can correctly detect the existence of the object within area 56 which may become the blind zone relating to first sensor 14. Therefore, first sensor 14 may be set so that first sensor 14 does not judge the presence or absence of the object within monitoring area 52, when first sensor 14 detects the object within intermediate area 58 relating to blind zone 56. Alternatively, similarly to the embodiment of FIG. 4, monitoring area 52 may be divided into area 56 corresponding to the blind zone and the other area, and only area 56 may be set as a non-detection area relating to first sensor 14.

Similarly, since first sensor 14 can correctly detect the existence of the object within area 60 of monitoring area 52 which may become the blind zone relating to second sensor 44, second sensor 44 may be set so that second sensor 44 does not judge the presence or absence of the object within monitoring area 52, when second sensor 44 detects the object within intermediate area 62 relating to blind zone 60. Alternatively, similarly to the embodiment of FIG. 4, monitoring area 52 may be divided into area 60 corresponding to the blind zone and the other area, and only area 60 may be set as a non-detection area relating to second sensor 44. As such, when the plurality of monitoring areas are detected by the plurality of sensors, the blind zone relating to one sensor can be detected by the other sensor, by appropriately determining the positional relationship between the monitoring areas and the sensors, whereby the object detection for each monitoring area can be properly carried out.

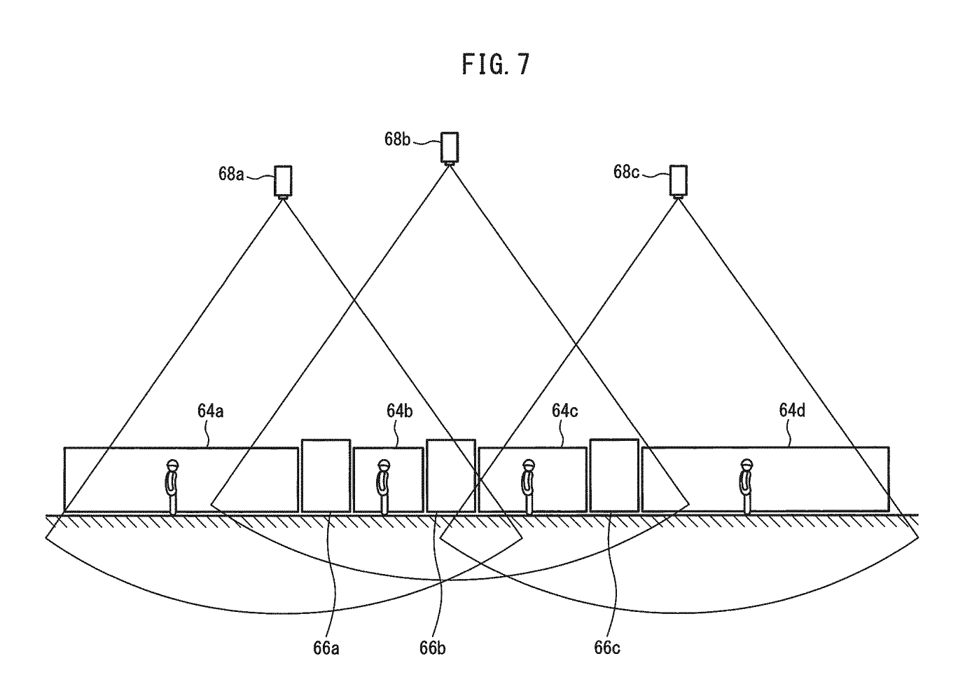

In the monitoring device according to the present disclosure, the number of the sensors can be easily increased. For example, as shown in FIG. 7, in case that operator areas 64a to 64d (where the operator may enter) and monitoring areas 66a to 66c (where existence or entrance of the operator should be monitored) are alternately positioned, by positioning the sensors so that one monitoring area is monitored by at least two sensors, the existence of the object in the monitoring areas can be fully detected, even if the blind zone may occur in the monitoring areas. For example, with respect to sensor 68b, although a blind zone may occur in a lower-right part of monitoring area 66a when the operator exists near a left edge in operator area 64b, the existence of the object in this blind zone can be detected by sensor 68a. Similarly, with respect to sensor 68b, although a blind zone may occur in a lower-left part of monitoring area 66c when the operator exists near a right edge in operator area 64c, the existence of the object in this blind zone can be detected by sensor 68c. As such, the number of the sensors may be increased with no limit, depending on the sizes and/or the numbers of the operator areas and the monitoring areas. Further, in each sensor, it is sufficient that a setting, as to whether or not the sensor detects the object within a predetermined measurement range, is configured. Therefore, it is not necessary to connect between the sensors, and thus an inexpensive monitoring device having a simple structure can be constituted.

As exemplified in FIG. 7, when the number of the monitoring areas or the sensors is relatively high, an optimum number of the sensors and/or optimum locations of the sensors, according to the sizes, the positions and the number of the monitoring areas, may be previously determined by a calculation (or simulation) using an assist tool such as a simulator (e.g., a personal computer), etc.

In the above embodiment, even when the sensor detects that the object exists in the intermediate area, the judging section (outputting section) does not output anything. Alternatively, when the sensor detects that the object exists in the intermediate area, the judging section (outputting section) may transmit an output (e.g., a non-detection signal) representing that the object detection in the monitoring area is not carried out (i.e., the judging section does not judge the presence or absence of the object within the monitoring area).

In the above embodiment, the sensor is a range sensor configured to obtain information (or measurement data) relating to the position of the object within the measurement range (or the spatial area). For example, the sensor may be: a triangulation-type distance measurement device having a projector optical system and a photodetector optical system; a stereo-type distance measurement device having two imagers (e.g., CCD cameras); a radar utilizing a reflection delay time of a radio wave; or a TOF sensor utilizing a reflection delay time of a light (e.g., a laser or a near-infrared ray), etc. However, the sensor is not limited as such.

In the above embodiment, the setting (e.g., the inputting the sizes and the positions) of the monitoring area and the intermediate area for the monitoring device may be previously carried out by an administrator of the monitoring system, through a suitable input device such as a keyboard or a touch panel. Otherwise, the judging section may automatically calculate the intermediate area, based on the information such as the input position and size of the monitoring area. Further, the judging section and the outputting section may be realized as software for activating a processor such as a CPU of a computer. Alternatively, the judging section and the outputting section may be realized as hardware such as a processor, for executing at least a part of processes of the software.

The monitoring device of the present disclosure can be previously set as to whether or not, when the object is detected in the intermediate area, the monitoring device judges that the object exists within the monitoring area on the grounds of the existence of the object within the intermediate area. Therefore, when the blind zone may occur in the monitoring area due to the object within the intermediate area, it is preferable that the monitoring device be set so as to not execute the above judgment, and the area in the monitoring area which may become the blind zone be monitored by another sensor. By virtue of this, even when the object (e.g., the administrator of the monitoring system) comes close to the monitoring area and the blind zone occurs in the monitoring area, it is not judged that the object exists in the monitoring area. Therefore, an unnecessary or excessive process (e.g., immediately stopping the dangerous object such as a robot in the monitoring area) is not executed, whereby the operator can safely and effectively carry out a work.

In order to correctly detect the object within a certain area corresponding to the blind zone, another sensor, positioned so that the certain area does not become the blind zone due to the existence of the object within the intermediate area, may be used. In this case, it is not necessary to connect the sensors via a network, etc., and it is sufficient that each judging section executes the judging process of the object with respect to the determined monitoring area and intermediate area based on the data from the sensor connected to the judging section, and outputs the result of the judging process.

In many cases, the monitoring device of the present disclosure is used as a safety apparatus, and in such a case, it is desired that a period of time from when the object in the monitoring area is detected to when the result of detection is output to another device be short as possible. In this regard, when the function as in the present disclosure is not used, it may be necessary to connect the plural sensors to one judging section, and/or use a plurality of high-speed networks in order to integrate and judge judgment results of the plurality of judging sections. On the other hand, in the present disclosure, it is not necessary to connect between the sensors, and it is not necessary to execute the object detection by integrating and judging the outputs from the plural sensors, whereby a sufficiently practicable monitoring device can be constituted at a low cost.

According to the present disclosure, the setting can be previously configured so that, when the object within the intermediate area is detected, the process for judging the presence or absence of the object in the monitoring area is not executed. Therefore, the disadvantage due to judging that the object exists in the monitoring area can be avoided, when the operator, etc., enters the intermediate area and the blind zone is generated in the monitoring area.

While the invention has been described with reference to specific embodiments, it will be understood, by those skilled in the art, that various changes or modifications may be made thereto without departing from the scope of the following claims.

1. A monitoring device comprising:
at least one sensor configured to a predetermined spatial area; and
a judging section configured to judge presence or absence of an object within a predetermined monitoring area in the spatial area, based on measurement data obtained by the sensor,
wherein the judging section is configured to be previously set as to whether or not, when the sensor detects that the object exists within an intermediate area between the sensor and the monitoring area, the judging section judges that the object exists within the monitoring area, on the grounds of the existence of the object within the intermediate area.

2. The monitoring device as set forth in claim 1, wherein a plurality of the monitoring areas are predetermined in the spatial area, and the intermediate area is defined for each of the monitoring areas.

3. The monitoring device as set forth in claim 1, wherein the judging section is previously set as to whether or not the judging section judges that the object exists within the monitoring area, on the grounds of the existence of the object within each of areas which are obtained by dividing the intermediate area.

4. The monitoring device as set forth in claim 1, further comprising an outputting section configured to output a result of judgment of the judging section,
wherein the outputting section outputs the result of judgment of the judging section with respect to each of a plurality of monitoring areas determined by the judging section, or with respect to each group which is obtained by integrating the monitoring areas.

5. The monitoring device as set forth in claim 1, wherein the sensor includes a first sensor and a second sensor arranged at a different position from the first sensor,
and wherein the judging section judges the presence or absence of the object within the monitoring area based on measurement data of the second sensor, in case that the judging section is previously set so that, when the first sensor detects that the object exists within the intermediate area between the first sensor and the monitoring area, the judging section does not judge that the object exists within the monitoring area.

6. The monitoring device as set forth in claim 5, wherein in the monitoring area, which is set so that the judging section judges does not judge the presence or absence of the object by the first sensor, a blind zone relating to the first sensor may occur in the monitoring area due to the existence of the object within the intermediate area between the first sensor and the monitoring area, and wherein the second sensor is positioned so that a blind zone relating to the second sensor does not occur in the monitoring area due to the existence of the object within the intermediate area between the first sensor and the monitoring area.

7. The monitoring device as set forth in claim 6, wherein the judging section judges that the object exists within the monitoring area, when the second sensor detects that the object exists the intermediate area between the second sensor and the monitoring area.
